(19) United States
(12) Patent Application Publication
(10) Pub. No.: US 2005/0021925 A1
(43) Pub. Date: Jan. 27, 2005

(54) Accessing in parallel stored data for address translation

(76) Inventors: Lawrence T. Clark, Phoenix, AZ (US); Shay P. Demmons, Chandler, AZ (US); Byungwoo Choi, Chandler, AZ (US); Dan W. Patterson, Scottsdale, AZ (US)

Correspondence Address: Timothy N. Trop;TROP, PRUNER & HU, P.C., STE 100, 8554 KATY FWY, HOUSTON, TX, 77024-1841, US

(21) Appl. No.: 10/626,968

(22) Filed: Jul. 25, 2003

(51) Int. Cl. G06F 12/08

(52) U.S. Cl. 711/203; 711/212

(57) ABSTRACT

A circuit to translate virtual addresses of varied page sizes into physical addresses enables selective access to an internally stored data in parallel to reading a specific physical address based on the input virtual address before the internally stored data matches in entirety for the address translation thereof. In one embodiment, a content addressed buffer may comprise at least two register files or static random access memories. For example, a banked architecture for a set associative translation lookaside buffer may reduce power consumption without compromising address translation speed.

### BACKGROUND

The present invention relates generally to memory hierarchy, and more particularly, to address translation buffers.

To increase system performance, designers of electronic devices focus on reducing power consumption and obviating speed bottlenecks on critical paths. A processor-based system often uses a cache memory to avoid frequent, cycle consuming accesses of system memory. Within the cache memory, a processor stores information in accordance with a predetermined mapping policy, such as direct, set associative or fully associative mapping. Using virtual addresses, a cache memory may be provided for a processor that may advantageously operate in a virtual address space. However, these virtual addresses must be translated into physical addresses.

By storing or caching the recently used virtual to physical address translations instead of repeatedly accessing translation tables stored in the system memory, a translation look aside buffer (TLB) may quickly accomplish address translation. A TLB is a special type of cache memory having multiple entries stored in a tag and associated data memories. A TLB entry normally comprises a tag value and a corresponding data entry. A fully associative TLB, which may be configured as a content-addressable memory (CAM), however, requires not only a relatively large chip area to implement but also redundant compare operations to operate, using commensurately greater power.

For ease of storage and retrieval, information in the system memory may be organized as pages. However, under certain circumstances, use of large page sizes of virtual addresses over the small page sizes may be desirable. As a result, support for address translation of the virtual addresses of different page lengths may be required within a system. Moreover, since generally all instructions and data addresses have to be translated, the power consumption is significant, especially for superscalar processors that involve multiple independent instructions per clock cycle.

Thus, there is a continuing need for alternate ways to efficiently translate virtual addresses of varied page sizes into physical addresses.

### BRIEF DESCRIPTION OF THE DRAWINGS

FIG. 1 is a block diagram of a system consistent with one embodiment of the present invention;

FIG. 2 is a block diagram of a content addressed buffer including at least two register files in accordance with an embodiment of the present invention;

FIG. 3 is a flow chart consistent with one embodiment of the present invention;

FIG. 4 is a schematic representation of a circuit capable of decoding and address selection for the content addressed buffer shown in FIG. 1 according to one embodiment of the present invention;

FIG. 5 is a hypothetical timing chart for the content addressed buffer shown in FIG. 1 in accordance with one embodiment of the present invention;

FIG. 6 is a schematic representation of a register file for the content addressed buffer shown in FIG. 1 consistent with one embodiment of the present invention;

FIG. 7 is a schematic representation of a circuit capable of masking bits for configuring page size according to one embodiment of the present invention; and

FIG. 8 is a schematic representation of another circuit including static random access memory cells for implementing the content addressed buffer shown in FIG. 1 in accordance with an alternate embodiment of the present invention.

### DETAILED DESCRIPTION

A system 10 consistent with one embodiment of the present invention may include a processor 20 coupled to a system memory 30, and an interface 35 that may couple the processor 20 to the system memory 30. Examples of the processor 20 include low power consumption microprocessors or digital signal processors (DSPs) for use with the system 10, such as personal digital assistants (PDAs) and cell phones. The system memory 30 may store program instructions and/or data for the processor 20 to execute on the system 10.

In the system 10, a non-volatile memory 40 coupled to the interface 35, persistently stores code and/or memory data. Examples of the non-volatile memory 40 include a flash memory, or another semiconductor non-volatile memory. A communication interface (I/F) 45 may be coupled to the interface 35 to communicate over a network. Likewise, a user interface 50 may be coupled to the interface 35 to provide a graphical user interface to interactively input data and/or instructions and obtain or receive appropriate responses on the system 10 in accordance with some embodiments of the present invention. For example, the user interface 50 may include a keypad, a display, and a microphone in some embodiments. The communication interface 45, however, may provide wired and/or wireless communications over networks, such as local area networks and cellular networks. As one example, the system 10 may be a cellular communication system capable of establishing a code division multiple access (CDMA) radio frequency (RF) communications.

The processor 20 may include an integrated circuit 55 having a logic device 60 coupled to a multiplicity of state holding elements 70. Some examples of the state holding elements 70 include latches and flip-flops. While the logic device 60 may enable the integrated circuit 55 to perform a variety of arithmetic and logic operations, the state holding elements 70 may desirably hold and keep track of different transitions of signals in the processor 20.

In some embodiments, the state holding elements 70 may include a translation lookaside buffer (TLB) 75 which may be a set associative content addressed buffer as described herein. The translation lookaside buffer 75 may receive a load or a store of a particular memory location of the system memory 30, triggering address translation by an application or the operating system, as two examples. For address translation, in one embodiment, the application may selectively access internally stored data based on an input virtual address in parallel to accessing a specific physical address corresponding to the input virtual address. As a result, the system 10 may translate virtual addresses of varied page sizes into physical addresses at relatively high address translation speeds while reducing power consumption in some embodiments.

Within the processor 20, the translation lookaside buffer 75 may allow software or the operating system setting of a preferred page size of the virtual address for translation versus associativity. Associativity refers to a characteristic of a cache, indicating where to place a block of memory data within the cache memory and how many entries are examined in parallel to determine a match. If a virtual address can be mapped in a restricted number of places in the translation lookaside buffer 75, the translation lookaside buffer 75 is a set associative translation lookaside buffer. A set is a group of two or more tags in the translation lookaside buffer. The virtual address is first mapped onto a set, and then the virtual address may be mapped anywhere within the set, providing a set associativity based on a number of places to which the virtual address may be mapped within a set.

The translation lookaside buffer 75 may comprise a first memory portion 80a for internally storing data based on an input virtual address and a second memory portion 80b that stores a specific physical address output corresponding to the input virtual address, according to one embodiment of the present invention. For address translation of the input virtual address into the specific physical address output, the first memory portion 80a may be selectively accessed in parallel to the second memory portion 80b. While the internally stored data in the first memory portion 80a may include a multiplicity of tags in one embodiment, the second memory portion 80b may store associated physical data.

The translation lookaside buffer 75 may receive a virtual address including the virtual address indexing data. The indexing data refers to a portion of the virtual address that is responsible for selecting the tags for comparison. A tag refers to a portion of the internally stored data that is responsible to select the specific data, outputting a corresponding physical address available for the virtual address. The address translation may begin by sending the indexing data to the sets to select the tags that are to be compared with corresponding data included in the virtual address indexing data. The matching tag may provide the corresponding physical address or specific physical data from the translation lookaside buffer 75.

In operation, the indexing data may be examined to identify at least two corresponding tags from the internally stored data of the first memory portion 80a. To this end, the indexing data may be compared with the two corresponding tags. However, before any one of the tags of the two corresponding tags in the internally stored data matches the indexing data, an enable signal may be generated to output the specific physical address from the translation lookaside buffer 75 in accordance with some embodiments of the present invention.

By applying the virtual (page) address to the first memory portion 80a, the internally stored data may be accessed from the translation lookaside buffer 75. Based on a comparison between the indexing data and the tag values stored within the first memory portion 80a, entries may be selected from the second memory portion 80b. In one embodiment, the second memory portion 80b may contain the corresponding physical address to the virtual (page) address and associated permissions for a corresponding page. In this way, consistent with one embodiment, the translation lookaside buffer 75 may perform an important function in a microprocessor, affording hardware protection to protect pages of memory as well as converting address types for enabling access to cache in processors which use physical address to address the caches.

In some embodiments, the translation lookaside buffer 75 may be a set associative TLB containing multiple TLB entries that hold virtual to physical mappings. For the set associative TLB, the mapping for a particular virtual address may be contained, only in a specific set of TLB entries. Since a TLB lies on a critical path in most microprocessor cache paths, especially in the data path access of physically addressed data caches, the translation lookaside buffer 75 may be configured as a set associative register file instead of a content-addressable memory (CAM). The critical paths are normally characterized by the logic signals that affect timing or cache accesses, for example, data paths may carry n-bit data addresses to and from the translation lookaside buffer 75, according to one embodiment.

Using the set associativity, the set associative TLB may implement multiple page sizes in an addressed memory, as opposed to a content-addressable memory (CAM), which uses full associativity. A TLB entry may be used to map a particular set of addresses. In this manner, the translation lookaside buffer 75, in some embodiments, may allow a comparison with relatively reduced power consumption because significantly less entries are compared (e.g., 4 to 8 rather than 32 or more depending upon set associativity). The internally stored data may be read in parallel with the compare, speeding the delivery of the permissions and the specific physical address. With a CAM based structure, the read of the physical address must follow the completion of the compare operation.

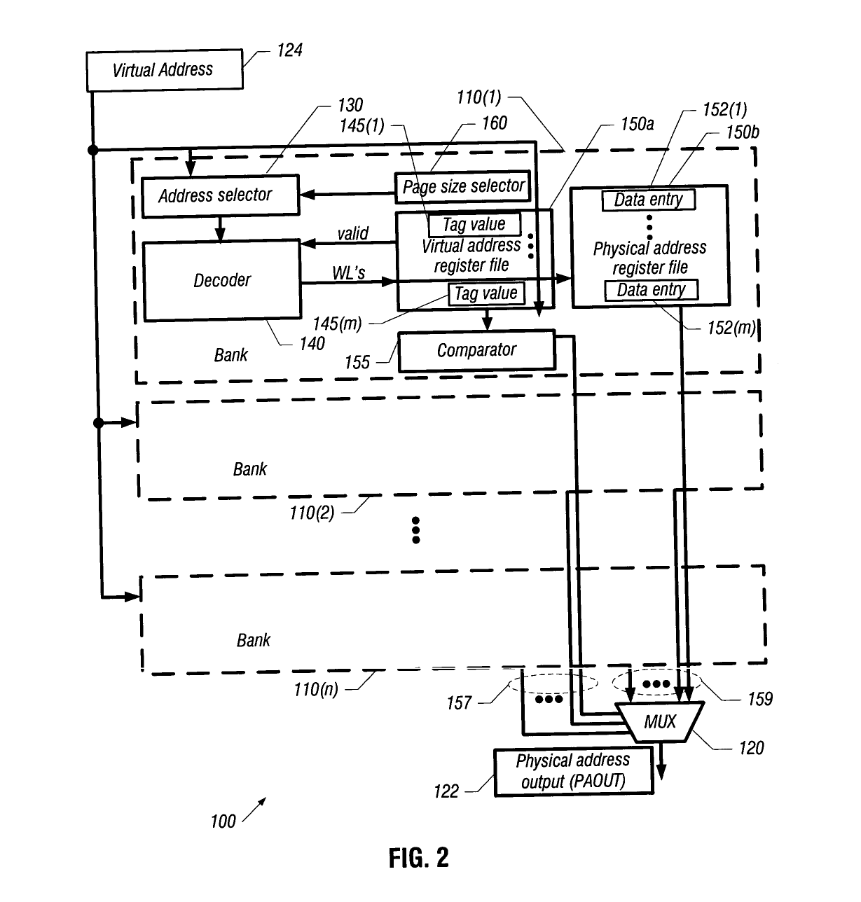

For translating virtual addresses of varied page sizes into appropriate physical addresses, the translation lookaside buffer 75 may comprise a content addressed buffer 100 that is an n-way set associative cache shown in FIG. 2 in accordance with one embodiment of the present invention. The content addressed buffer 100 may comprise a multiplicity of data banks 110 (1) to 110 (n) and a multiplexor 120 to select the specific physical address output 122 from the multiplicity of data banks 110 (1) to 110 (n) in response to an input virtual address 124.

A data bank 110 (1) may comprise an address selector 130 to receive indexing data within the input virtual address 124. As described above, for identifying at least two corresponding tags from the internally stored data in the data bank 110 (1) the indexing data may be examined, as one example. Furthermore, the content addressed buffer 100 may comprise a decoder 140 coupled to the address selector 130 for the purposes of decoding the input virtual address 124. To hold the internally stored data, such as tag values 145(1) through 145(m), the data bank 110 (1) may include a virtual address register file 150a. Likewise, for storing data entries 152(1) through 152(m) for the specific physical address output 122, the data bank 110(1) may further comprise a physical address register file 150b. Both of the virtual and physical address register files 150a, 150b, in one embodiment, comprise a multiplicity of write, and read ports.

Before accessing the virtual and physical address register files 150a and 150b, the decoder 140 may decode the input virtual address 124. This decoding of the input virtual address 124 may enable simultaneous access to the tag values 145(1) through 145(m) and the data entries 152(1) through 152(m). A comparator 155 may be coupled to the virtual address register file (150a) to determine the tags to compare via the index.

An enable signal 157 to the multiplexor 120 from any one of the multiplicity of data banks 110 (1) to 110 (n) may cause the content addressed buffer 100 to output the specific physical address output 122 in response to a signal 159 when one of the tags in the internally stored data matches the required address (sent to the compare). A page size selector 160 may select the number and position of compared bits for the input virtual address 124 based on the selected page size. While the virtual address register file 150a may provide the multiplicity of tag values 145(1) through 145(m) in the internally stored data, the physical address register file 150b provides physical address data entries 152(1) through 152(m) for the specific physical address output 122.

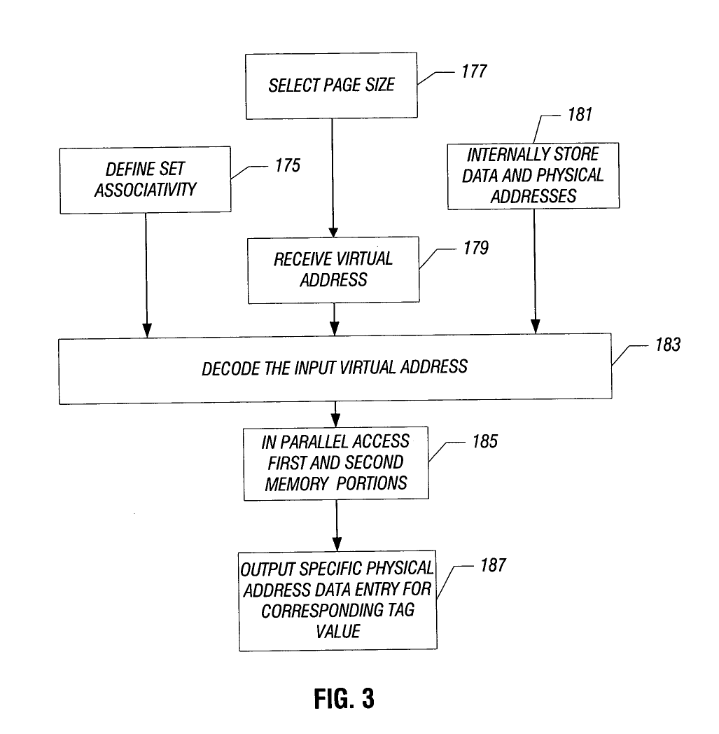

Referring to FIG. 3, in one embodiment, a set associativity for a multiplicity of virtual memory locations that hold the data entries 152(1) through 152(m) may be defined at block 175. However, in some embodiments, the set associativity is fixed for all page sizes. A particular data entry of the data entries 152(1) through 152(m), indicative of the physical address value corresponding to the virtual address 124 shown in FIG. 2, may include an input data word, as the indexing data. In one case, the data entry 152(1) may be read from the physical address register file 150b for address translation of the virtual address into a specific data physical address. The comparator 155 illustrated in FIG. 2 may compare the input data word to the tag value(s) 145 in the virtual address register file 150a.

Using any one of the multiplicity of virtual memory locations based on the set associativity, the virtual address may be translated into the specific data physical address. The page size for the virtual address may be selected at block 177 before receiving the virtual address at block 179. At block 181, the tag values 145(1) through 145(m) and the data entries 152(1) through 152(m) for physical addresses may be stored internally in the virtual and physical address register files 150a and 150b, respectively.

By decoding the virtual address, as indicated at block 183, before accessing in parallel the virtual and physical register files 150a, 150b, at block 185, the virtual address of varied page sizes may be translated into the specific data physical address. In doing so, the physical address register file 150a may fire simultaneously with the virtual address register file 150a, efficiently translating the virtual address into the specific data physical address at block 187 while reducing power consumption and increasing speed of address translation in some embodiments of the present invention.

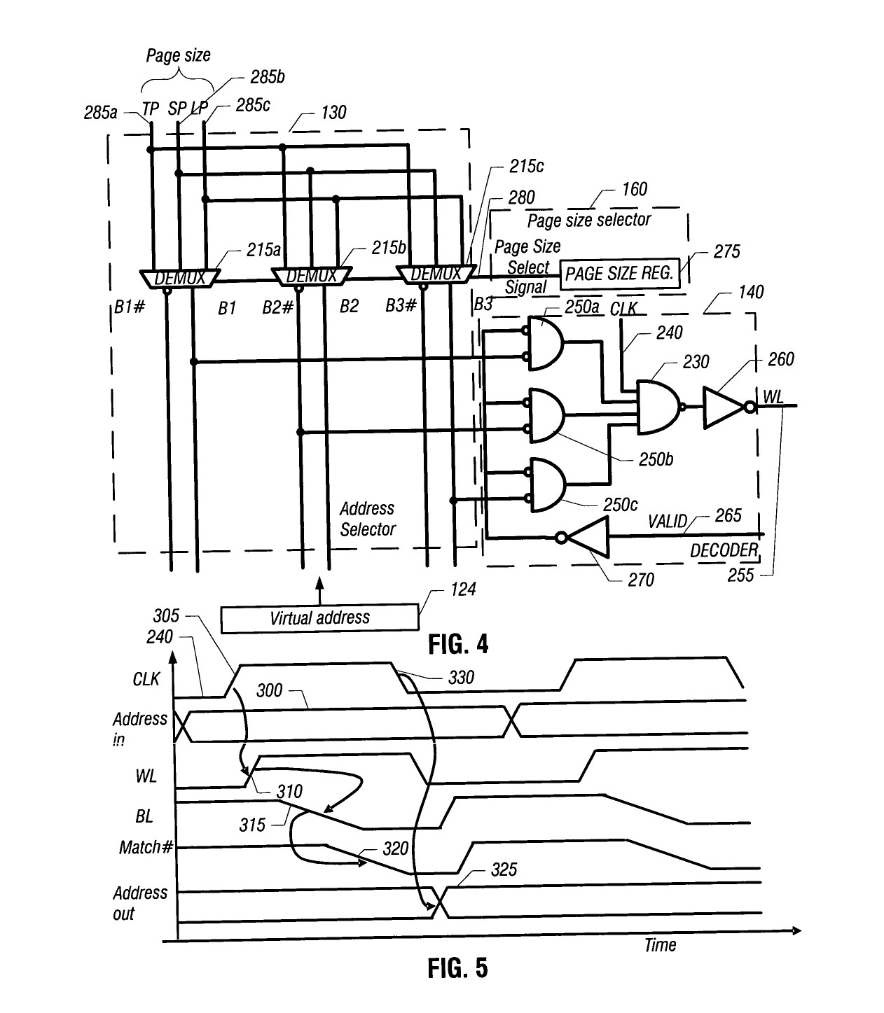

Referring to FIG. 4, the address selector 130, the decoder 140, and the page size selector 160 may cooperatively provide decode and address selection for the content addressed buffer 100 shown in FIG. 2, according to one embodiment of the present invention. While the circuit for address selector 130 may comprise a multiplicity of demultiplexors (DEMUXs) 215a, 215b, 215c, the decoder 140 may include a wordline select logic. The demultiplexors 215a-215c may select the virtual address that the decoder 140 may decode using the wordline select logic, in one embodiment.

To this end, the wordline select logic of the decoder 140 may comprise a multi-input NAND gate 230. The NAND gate 230 may receive a clock (CLK) input 240 and outputs from three NOR gates 250a, 250b, and 250c to provide a wordline (WL) fire signal 255 through an inverter 260 coupled at the NAND gate 230 output. Each of the NOR gates 250a-250c receives an inverted valid signal 265 via an inverter 270 at one of the two inputs. The other inputs of the NOR gates 250a-250c may be coupled to a corresponding demultiplexor input of the demultiplexors 215a through 215c. Using the inverted valid signal 265, an invalid entry may gate the WL fire signal 255, ensuring that no other WL is asserted in that bank in such a case, further saving power. Accordingly, a miss is forced for an invalid entry. It should be noted that there are many variations in the way that this logic could be implemented.

The page size selector 160 may comprise a register 275, providing a page size select signal 280 to the demultiplexors 215a-215c in the address selector 130. Each of the demultiplexors 215a-215c may receive the page size select signal 280 indicative of any one of varied page sizes. The demultiplexors 215a-215c, based on the page size select signal 280 which indicates the number of bits and location thereof selected from the virtual address 124 may selectively provide page size signals 285-285c, e.g., TP, SP, LP. For example, the demultiplexor 215a may receive signals B1# and B1. Without limiting the scope of the present invention, a “#” symbol is used in the description to indicate the logical complement of a signal, e.g., from one state to another i.e., a high logic “1” a low logic “0.”

In operation, depending on the size of the page selected at the register 275 in the page size selector 160, a different number and location of bits may be selected from the input virtual address 124 shown in FIG. 2. Thus, a different page size may be selected for a data bank, for example, the data bank 110 (1). For a 32 entry translation lookaside buffer, as one example, using the decoder 140, the input virtual address 124 may be decoded to indicate which one of the eight virtual addresses in the data bank 110 (1) to select for a given page size. Since the virtual address register file 150a stores the tag values 145(1) through 145(m) for the input virtual address 124, the WL signal 255 may access only one virtual address to translate into the corresponding physical address out of eight corresponding physical addresses stored in the physical address register file 150b because the virtual addresses are selected based on the page size and decoded based on that as well.

For the purposes of decoding, the input virtual address 124 is presented to the decoder 140 as shown in FIG. 4. The incoming address bits of the input virtual address 124 may be de-multiplexed to the decoder 140 gates. However, in another embodiment, to support multiple page sizes, multiple decoders may be provided, i.e., one for each page size in each bank. The register 275 may store one or more bits to indicate at each bank; the page size used by that bank, selecting the de-mux path to be used for the corresponding page size. At reset, the page sizes may be set so that each page size can be used by at least one bank.

The virtual address data from the virtual address register file 150a may be applied to the comparator 155 while the corresponding physical address is sent to the multiplexor 120 so that when a match happens in the comparator 155, the corresponding physical address may be provided immediately, in some embodiments of the present invention. However, the match may only happen for one data bank at a time. Having the set associativity between the data banks 110 (1) through 110 (n) shown in FIG. 2, storing of the same physical addresses in multiple banks may be avoided.

For example, the address selector 130 and the decoder 140 may form a 3-to-8 decoder, out of eight only one wordline is fired at a time, i.e., only the wordline signal 255 may be generated depending upon the page size select signal 280 which determines a specific demultiplexor that will be turned on out of the demultiplexors 215a-215c or the number of bits and their location that may be applied thereto. Depending upon the page size indicated in the register 275, different number of bits may be used to decode, indicating the selection of the virtual address corresponding to which the physical address may be obtained.

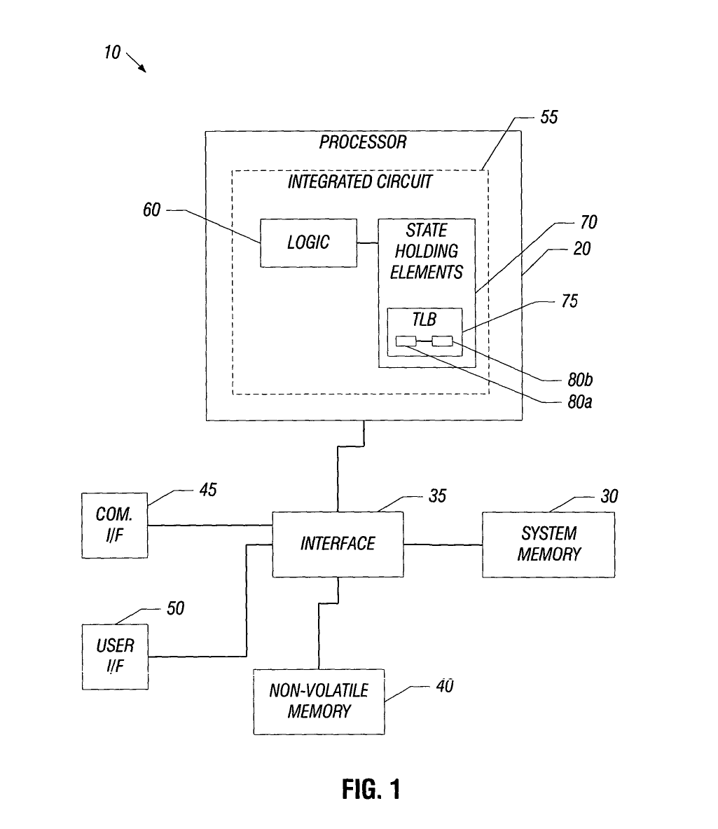

The address selector 130 and the decoder 140 may allow software to configure the translation lookaside buffer 75 shown in FIG. 1 depending upon the code being used. Typically, a given operating system (OS) supports only a few or one page size (one in the case of Linux® and two in Microsoft® WinCE), so the OS may set the registers 275 to prefer those page sizes. In some embodiments, this may afford potentially the same architectural efficiency as the CAM based TLB but at an improved power and delay metrics. In the ARM® microprocessor architecture (as well as most others), multiple page sizes may be supported.

Referring to FIG. 5, a hypothetical timing chart shows that to translate an address input 300, i.e., the virtual addresses, e.g., the input virtual address 124 may be applied to the decoder 140 shown in FIG. 4 before a clock edge 305 in accordance with one embodiment of the present invention. By firing 310 a wordline signal, e.g., the WL fire signal 255 shown in FIG. 4 may be asserted on that clock edge 305. Some bits on a bitline signal 315 may be provided earlier before the match is indicated by a match signal 320. In this manner, an address output 325 may be delivered after the phase clock, i.e., a falling clock edge 330 of the clock signal 240.

Since the access is decoded, accessing the physical address register file 150b comprising the data entries 152(1) through 152(m) may be accomplished in parallel with the compare operation by the comparator 155, making the address translation relatively fast. In this way, the physical address register file 150b read may be finished with the appropriate physical address set up to the multiplexor 120 inputs. The compare operation is set up to the opposite clock edge to the one that began the operation (i.e., the falling clock edge 330). The clock edge 305 provides a timing signal that allows the matching bank (way) to select the corresponding data entry (the physical address) to the output bus, as shown in FIG. 2. Since the high speed compare (dynamic) starts with all entries in the match state it is necessary to wait for the clock timing edge before choosing the final matching entry.

In accordance with one embodiment of the present invention described above, the content addressed buffer comprising the TLB 100 may dissipate as little as ⅛ the power in the comparator 155 shown in FIG. 2, while delivering the physical address after the phase clock, nearly ½ clock cycle earlier than a CAM based TLB. Multiple page sizes may be handled while using a banked architecture for the content addressed buffer 100, a larger TLB may be relatively faster and have reduce power consumption than a comparable CAM based design in other embodiments.

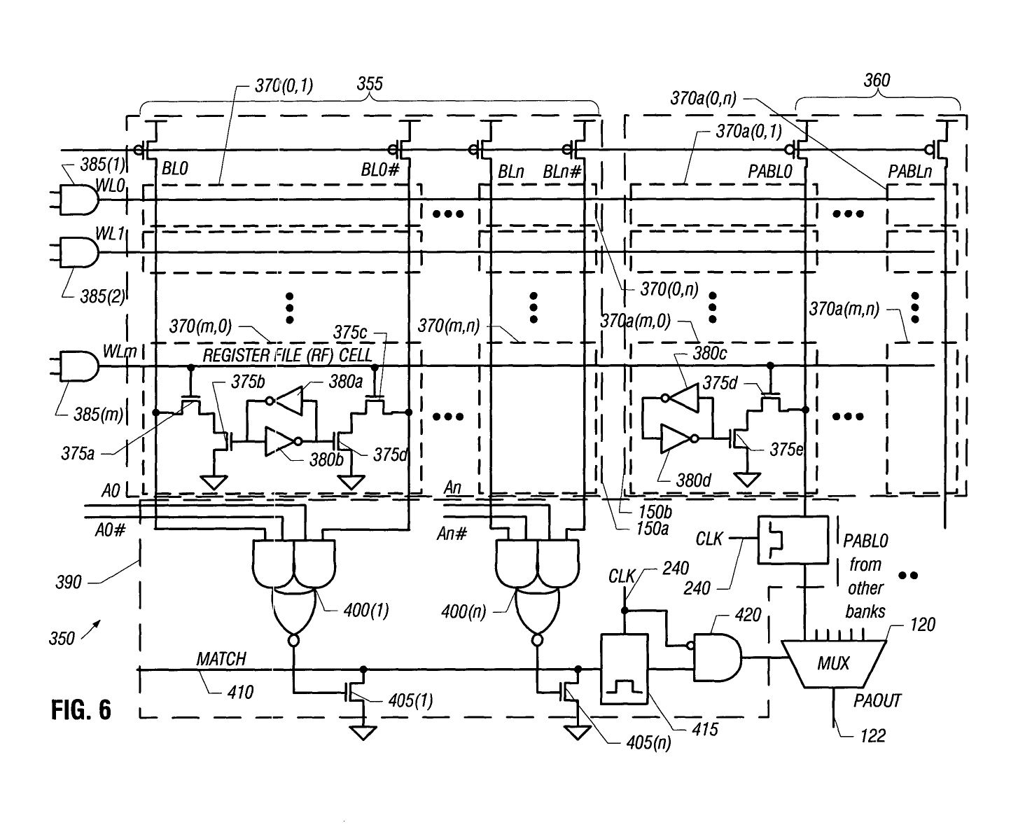

A register file circuit 350, as shown in FIG. 6, uses differential bitlines 355 for a relatively fast exclusive-oring in the virtual address store, while single-ended bitlines 360 are used in the physical address store, reducing significantly power consumption for the content addressed buffer 100 shown in FIG. 2, according to one embodiment of the present invention. The virtual register file 150a may comprise an array of register file cells 370(0) through 370 (m,n). The register file cell 370 (n,0) includes a conventional register file of which only the read portion is shown.

For example, conventional register files are generally fast random access memories (RAM) with multiple read and write ports that may be implemented by adding pass transistors. In particular, the read portion of the register file circuit 350 in the register file cell 370 (n,0) includes transistors 375a through 375d coupled to storage inverters 380a and 380b, forming a read port. Likewise, a conventional write-port implementation using transistors may be provided for the register file cell 370 (n,0) in some embodiments of the present invention.

NAND gates 385(1)-385(n) may be coupled to a corresponding writeline (WL) of a multiplicity of writelines WL0 through WLm that may further couple to a respective register file cell of the array 370 (0,1) through 370 (m,n). The differential bitlines 355 may couple in pairs to the corresponding register file cells. For example, bitlines BL0 and BL0# may be coupled to the register file cells 370 (0,1) through 370 (m,0).

To compare the input virtual address 124 (FIG. 2) at a bit level, the register file circuit 350 includes a match circuit 390. The match circuit 390 may comprise a multiplicity of exciusiveor (XOR) gates 400(1) through 400(n) coupled to a corresponding pull-down transistor of a multiplicity of pull-down transistors 405(1) thorough 405(n). That is, the output of an exclusive or gate, e.g., 400(1) may be coupled to the pull-down transistor 405(n). The differential bitlines 355 and the bits in the virtual address 124 may drive the exclusive or gates 400(1) through 400(n). Specifically, input to the exclusive or gate 400(1) includes the address bits A0, A# and the bitlines BL0 and BL0#.

The pull-down transistors 405(1) through 405(n) may be coupled to a match line 410. The match line 410 may drive a latch 415, which may be further coupled, to an AND gate 420. The clock signal 240 may be applied to the latch 415 while an inverted clock may drive the AND gate 420. The output of the AND gate 420 may enable the MUX 120 to select one of a specific physical address data from the physical address bitlines PABL0 through PABLn 360, outputting the physical address output (PAOUT) 122. The physical address bitlines 360 may be clocked using the clock signal 240 to be synchronized with the output of the AND gate 420, indicating whether or not a match occurs between the virtual address bits A0 through An including their inverted signals A0# through An# and the corresponding differential bitlines' 355 bit pairs.

In operation, on a rising edge of the clock signal 240, the writeline, e.g., WLm may get activated. By comparing at the bit pair of the differential bitlines 355, e.g., bitlines BL0 and BL0# with the address bits A0 and A0# in the exclusiveor gate 400(1), the match circuit 90 may determine a match or a mismatch therebetween. In case the bitline bit pair and the address bits do not match, the output of the XOR gate 400(1) becomes high, pulling the match line 410 to a low state, i.e., storing the match line signal into the latch 415. If any one the bits do not match for a particular virtual address, the match circuit 390 may indicate that the entry is not a matching entry. This mismatch state is then captured by the latch 415 and on the falling edge of the clock signal 240 that output is not selected by the MUX 120.

After the matching of the bits, the latch 415 latches or stores the state for the next phase clock on the clock signal 240. Based on the output from the match circuit 390 to the MUX 120, indicating that all the bits matched via a high signal state, the physical address output (PAOUT) 122 is selected by the MUX 120. Otherwise, the MUX 120 may deselect the PAOUT 122, indicating a mismatch between the virtual address bits A0 through An including the inverted versions and the differential bitline 355 bit pairs.

From a power consumption point of view, in accordance with some embodiments of the present invention, each compare may use essentially the same power as one entry of the CAM, so that a four-way set associative register file circuit for the content addressed buffer 100 shown in FIG. 2 may use ⅛ the power of a 32 entry CAM and an eight-way design ¼th. Typically, this power dominates the total TLB power. Because the register file circuit 350 uses power sooner than that used by a CAM physical address register file, the delay vs. power tradeoff is relatively favorable. The power consumption by the decoder 140 is mitigated by the use of the demultiplexed address bits, which also mitigates any increase in block size in many embodiments of the present invention.

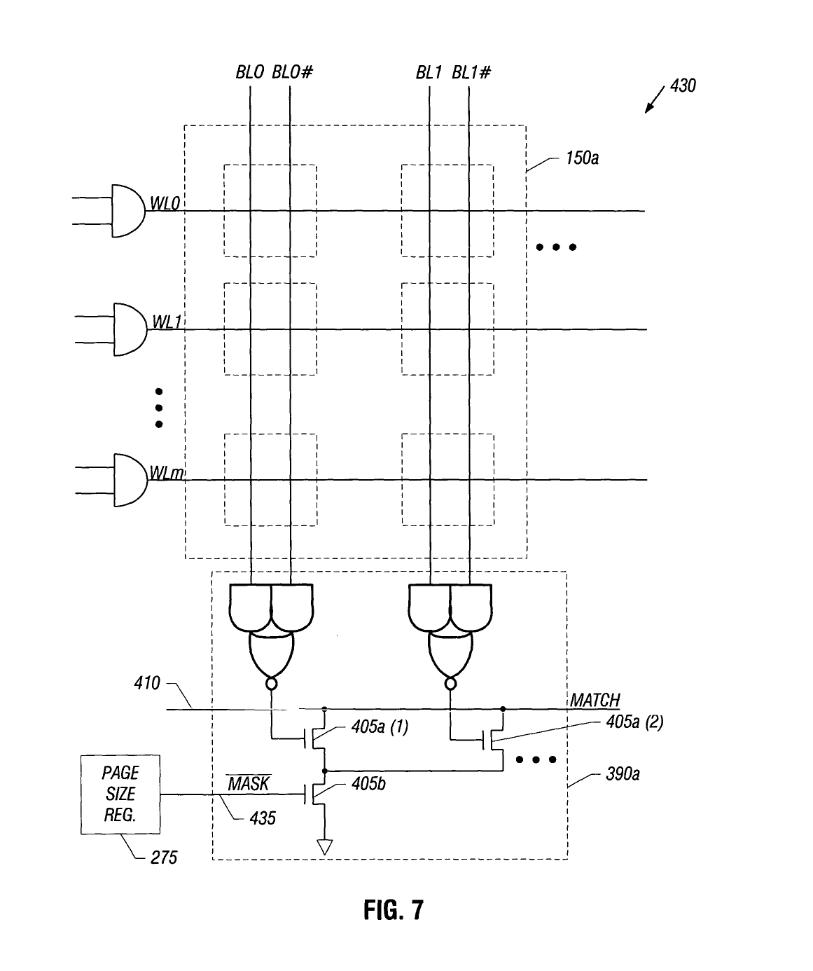

A circuit 430 capable of masking bits for configuring page size is shown in FIG. 7 according to one embodiment of the present invention is shown for the register file circuit 350 illustrated in FIG. 6. Specifically, the virtual address register file 150a may be coupled to a match circuit 390a. The register 275 may provide an inverted masking signal (MASK#) 435 to drive a pull-down transistor 405b coupled to pull-down transistors 405a(1) and 405a(2). The pull-down transistors 405a(1) and 405a(2) determine the state of a signal on the match line 410 depending upon whether or not the match happens between the bits of the input virtual address and the internally stored data within the virtual address register file 150a.

However, the number and position of compared bits varies with page size selected by setting the register 275. Based on the setting in the register 275 that indicates a particular page size selection, the mask signal 435 may remove certain number and position of bits from the comparison when indicated to be in a low state. In this manner, depending upon different page sizes, different bits may be masked off by not including in the comparison of bits done at the match circuit 390a. For instance, in the ARM® V5 microprocessor architecture, page sizes and masking bits may vary from 1K byte (B) with no masking of 31:10 bits, 4 KB with 2 bit masking in 31:12 bits, 64 KB with masking of bits 15, 14, 13, 12 in 31:16 bits, and 1 mega (M)B no masking of 31:20 bits. When 1 KB page size is selected, all 31:10 bits are compared. In case 4 KB page size is selected, while 31:12 bits are compared, the bits 11 and 10 are masked.

Consistent with one embodiment, the content addressed buffer 100 shown in FIG. 2 is amenable to storing addresses in static random access memory (SRAM) rather than register files and sensing them using sense amplifiers. This SRAM based the content addressed buffer 100 may enable implementation of a relatively large, e.g., 512 entry and larger second level TLB's at low power and much improved density, while supporting multiple page sizes that may be desired for architectural compatibility.

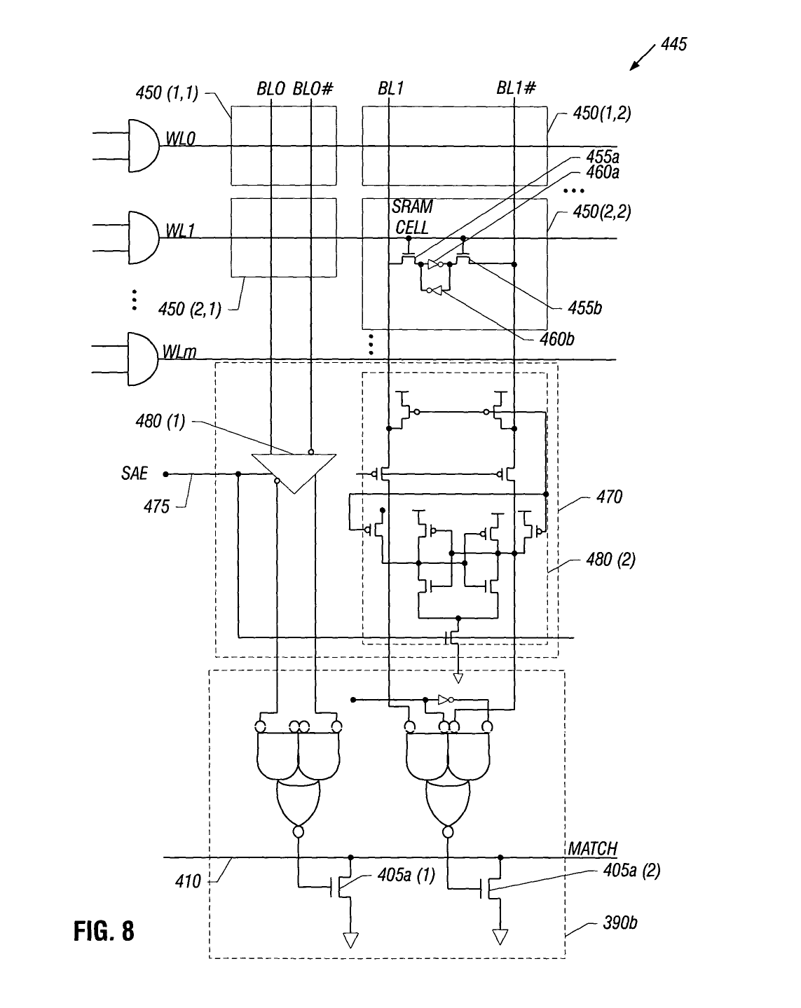

A circuit 445 as shown in FIG. 8 may include a SRAM cell array of cells 450 (1,1) through 450(m,n), forming a SRAM-based content addressed buffer according to one embodiment. Specifically, the SRAM cell 450 (2,2) may comprise a pair of transistors 455a and 455b coupled to storage inverters 460a and 460b for storing the internally stored data in one embodiment of the present invention. A pre-charge circuit 470 may be coupled to a match circuit 390b to translate the input virtual address 124 (FIG. 2) into a corresponding physical address in some embodiments of the present invention.

While the pre-charge circuit 470 may receive an enable signal 475 (e.g., SAE signal) to activate a sense amplifier 480, the match circuit 390b provides a match signal on the match line 410 in one embodiment of the present invention. A latching sense amplifier 480(2) for use with dynamic cascade voltage switch logic (CVSL) may be coupled on the bitlines BL1 and BL1#, providing the pre-charged operation in the pre-charge circuit 470 consistent with one embodiment of the present invention. Of course, other circuit architectures may be deployed in different embodiments of the present invention. For example, using small signal differential sensing amplifiers, data relevant to the virtual and physical addresses may be stored in the SRAM cell array of the cells 450(1,1) through 450(m, n) for address translation.

Since all stored tags are accessed in parallel in a CAM and a CAM implements a logical OR function in which any mismatching bits discharge the match line corresponding to that entry, and further, that all but one entry must discharge to reveal the matching entry, CAM's dissipate considerably greater power than a circuit with less associativity, such as the circuits 430 and 455. CAM circuits are also much larger and scale poorly, for example, in one scenario comparable CAM cells may be more than 4× the SRAM cell size. Additionally, the data portion of the memory cannot be accessed until a match has been determined, typically at the end of one clock phase. Consequently, the physical address is delivered approximately one clock cycle after the virtual address is presented to the CAM.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
reading a second memory portion that stores a specific physical address corresponding to an input virtual address before internally stored data accessed from a first memory portion based on the input virtual address entirely matches the input virtual address.

2. The method of claim 1, including using at least two register files, one for said first memory portion and the other for said second memory portion.

3. The method of claim 2, including decoding the input virtual address before accessing said at least two register files, wherein said at least two register files having a multiplicity of write and read ports that enable and simultaneously accessing to the internally stored data and said specific physical address output.

4. The method of claim 1, wherein matching includes:
storing a multiplicity of tags in the internally stored data;
receiving indexing data within the input virtual address;
examining said indexing data to identify corresponding at least two tags from the internally stored data;
comparing said indexing data with said at least two tags; and
after any one of the tags of said at least two tags in the internally stored data matches said indexing data, signaling an enable signal to output the specific physical address output.

5. The method of claim 2, including:
storing an identifying data value in said one of said at least two register files for the specific physical address output; and
storing a specific data associated with the identifying data value for the specific physical address output in the other register file of said at least two register files.

6. The method of claim 5, including accessing the second memory portion for the specific data before a match occurs between the identifying data value and the specific data.

7. A method comprising:
reading a physical address value corresponding to a virtual address that includes an input data word for address translation of said virtual address into a specific data address; and
comparing the input data word to internally stored data in parallel with said reading.

8. The method of claim 7, including:
selecting a page size for the virtual address;
varying the number and position of compared bits for the virtual address based on the selected page size; and
if any one of the internally stored data matches the input data word, signaling an enable signal to output the specific data address.

9. The method of claim 8, including defining a set associativity for a multiplicity of virtual memory locations that hold the internally stored data and translating the virtual address using any one of the multiplicity of virtual memory locations based on the set associativity.

10. The method of claim 9, including storing the internally stored data in a first register file adapted to fire simultaneously with a second register file and decoding selected bits of the virtual address before accessing said first and second register files wherein the selected bits are indicative of a bank page size.

11. A content addressed buffer comprising:
a data bank including a first memory portion to store internally stored data selectively accessible based on an input virtual address and a second memory portion accessible in parallel to said first memory portion to translate the input virtual address into a specific physical address before the internally stored data entirely matches the input virtual address.

12. The content addressed buffer of claim 11, including a multiplexer to select the specific physical address output from said data bank.

13. The content addressed buffer of claim 12, said first memory portion is a virtual address register file, and said second memory portion is a physical address register file, wherein each of said virtual and physical address register files having a multiplicity of write and read ports.

14. The content addressed buffer of claim 13, further including a selector to select the number and position of compared bits for the input virtual address based on the page size selected, wherein said virtual address register file to store a multiplicity of tags in the internally stored data and said physical address register file to store the specific physical address output.

15. The content addressed buffer of claim 14, wherein said data bank including:
an address selector to receive indexing data within the input virtual address to examine said indexing data and to identify corresponding at least two tags from the internally stored data;
a decoder, coupled to said address selector, to decode the input virtual address before accessing said virtual and physical address register files to enable simultaneous access to the internally stored data and said specific physical address output, respectively; and
a comparator, coupled to said decoder, to compare said indexing data with said at least two tags and after any one of the tags of said at least two tags in the internally stored data matches said indexing data, signaling an enable signal to said multiplexer to output the specific physical address output.

16. A system comprising:
a processor having a content addressed buffer with a data bank including a first memory portion storing internally stored data accessible selectively based on an input virtual address and a second memory portion accessible in parallel to said first memory portion for translation of the input virtual address into a specific physical address before the internally stored data entirely matches the input virtual address and the internally stored data; and
a flash memory coupled to said processor.

17. The system of claim 16, wherein said content addressed buffer is a set associative translation look aside buffer.

18. The system of claim 16, said first memory portion is a virtual address register file, and said second memory portion is a physical address register file, wherein each of said virtual and physical address register files having a multiplicity of write and read ports.

19. The system of claim 16, said first memory portion is a first static random access memory that stores a virtual address, and said second memory portion is a second static random access memory that stores a physical address.

20. The system of claim 19, said content addressed buffer further includes a selector to select a page size for the input virtual address and a register to select the number and position of compared bits for the input virtual address based on the selected page size.

21. A processor comprising:
a content addressed buffer with a data bank including a first memory portion storing internally stored data selectively accessible based on an input virtual address and a second memory portion accessible in parallel to said first memory portion for translation of the input virtual address into a specific physical address before the internally stored data entirely matches the input virtual address.

22. The processor of claim 21, wherein said content addressed buffer is a set associative translation look aside buffer.

23. The processor of claim 21, said first memory portion is a virtual address register file, and said second memory portion is a physical address register file, wherein each of said virtual and physical address register files having a multiplicity of write and read ports.

24. The processor of claim 21, said first memory portion is a first static random access memory that stores a virtual address, and said second memory portion is a second static random access memory that stores a physical address.

25. The processor of claim 24, said content addressed buffer further includes a selector to select a page size for the input virtual address and a register to select the number and position of compared bits for the input virtual address based on the selected page size.
